(19) United States
(12) Patent Application Publication
(10) Pub. No.: US 2026/0203671 A1
(43) Pub. Date: Jul. 16, 2026

(54) SYSTEMS AND METHODS FOR AUTOMATED ENSEMBLE STRATEGY SELECTION USING SPLIT VALIDATION SETS

(71) Applicant: Verseon International Corporation, Fremont, CA (US)

(72) Inventors: Elliot Farmer Garcia, Houston, TX (US); Brandon Warner, Waco, TX (US); Edward Ratner, Stirling, NJ (US); Christopher J Douglas, Coralville, IA (US)

(73) Assignee: Verseon International Corporation, Fremont, CA (US)

(21) Appl. No.: 19/447,091

(22) Filed: Jan. 13, 2026

Related U.S. Application Data
(60) Provisional application No. 63/745,249, filed on Jan. 14, 2025.

(51) Int. Cl. G06N 20/20

(52) U.S. Cl. CPC G06N 20/20

(57) ABSTRACT

Systems and methods are disclosed for automated ensemble strategy selection in machine learning using split validation sets. An input dataset is partitioned into a training set and a validation set, wherein the validation set is further subdivided into a first validation subset and a second validation subset. The first validation subset is used to optimize ensemble parameters for a plurality of candidate ensemble strategies, and the second validation subset is used to evaluate the candidate ensemble strategies and select an optimal ensemble strategy. The system supports classification and regression tasks and can be integrated into automated machine learning pipelines.

### CROSS-REFERENCE TO RELATED APPLICATIONS

This application claims the benefit of U.S. Provisional Patent Application No. 63/745,249, filed Jan. 14, 2025, entitled “AutoML Framework for Ensembling: Split Validation Sets for Coefficient and Structure Selection,” the entire disclosure of which is hereby incorporated by reference in its entirety.

### BACKGROUND

Ensemble learning techniques are widely used in machine learning systems to improve predictive performance by combining the outputs of multiple base models. Conventional ensemble approaches include, for example, bagging, boosting, random forests, gradient boosting, and voting-based ensembles. These techniques typically rely on training a collection of base learners and aggregating their predictions using fixed or learned weighting schemes.

Automated machine learning (AutoML) frameworks have emerged to reduce the need for manual model selection, hyperparameter tuning, and pipeline configuration. Existing AutoML systems commonly automate preprocessing, model selection, and hyperparameter optimization, and in some cases generate ensembles from a library of candidate models. For example, some AutoML frameworks employ static ensemble selection procedures that rank candidate models or incrementally build ensembles based on performance measured on a single validation dataset.

However, existing ensemble selection techniques in AutoML systems generally rely on a single validation set both to optimize ensemble parameters (such as model weights) and to evaluate competing ensemble configurations or strategies. This practice can lead to data leakage, overfitting to the validation data, or biased selection of ensemble structures that do not generalize well to unseen data. Moreover, conventional AutoML systems typically assume a fixed ensemble strategy (e.g., voting, weighted averaging, or stacking) and do not dynamically select among multiple ensemble strategies based on dataset-specific characteristics. As a result, current AutoML frameworks lack a robust mechanism for independently optimizing ensemble parameters while also objectively selecting among different ensemble selection strategies, particularly across both classification and regression tasks.

Therefore, there is a need for an automated ensemble selection system that prevents data leakage during ensemble optimization while automatically selecting an optimal ensemble strategy from among a diverse pool of candidate strategies based on the specific characteristics of the input data.

### BRIEF DESCRIPTION OF THE DRAWINGS

FIG. 1 is a block diagram illustrating an automated machine learning (AutoML) ensemble selection system architecture using split validation sets, according to some embodiments of the present technology.

FIG. 2 is a diagrammatic representation of a machine in the example form of a computer system within which a set of instructions, for causing the machine to perform any one or more of the methodologies discussed herein, can be executed.

FIG. 3 is a block diagram illustrating a dataset partitioning and split validation architecture, according to some embodiments of the present technology.

FIG. 4 is a flowchart illustrating a method for automated ensemble strategy selection using split validation sets, according to some embodiments of the present technology.

FIG. 5 is a block diagram illustrating classification ensemble strategy selection using split validation sets, according to some embodiments of the present technology.

FIG. 6 is a block diagram illustrating regression ensemble strategy selection using split validation sets, according to some embodiments of the present technology.

In the drawings, some components and/or operations can be separated into different blocks or combined into a single block for discussion of some of the implementations of the present technology. Moreover, while the technology is amenable to various modifications and alternative forms, specific implementations have been shown by way of example in the drawings and are described in detail below. The intention, however, is not to limit the technology to the particular implementations described. On the contrary, the technology is intended to cover all modifications, equivalents, and alternatives falling within the scope of the technology as defined by the appended claims.

### DETAILED DESCRIPTION

The present technology relates to automated machine learning (AutoML) systems and methods for selecting an ensemble strategy using split validation sets. The disclosed systems and methods address the training phase of machine learning, specifically the process of constructing and selecting an ensemble model; model prediction or inference, which is a separate phase, remains unaffected other than by having a different (improved) trained model available. In contrast to conventional AutoML frameworks that rely on a single validation dataset for both ensemble parameter optimization and ensemble strategy selection, the disclosed technology employs at least two distinct validation subsets to isolate these operations.

In some embodiments, an input dataset is partitioned into a training portion and a validation portion, wherein the validation portion is further subdivided into a first validation subset and a second validation subset. The first validation subset is used to compute ensemble parameters, including model weights or coefficients, for each of a plurality of candidate ensemble strategies. The second validation subset is used to evaluate the performance of the candidate ensemble strategies using the previously computed parameters, thereby selecting an ensemble strategy that is predicted to generalize to unseen data.

The disclosed system selects among multiple ensemble strategies, including classification-specific and regression-specific strategies, without requiring manual configuration. By isolating weight optimization from strategy evaluation, the system reduces data leakage, improves generalization performance, and provides a technical improvement to the operation of machine learning training pipelines.

In various embodiments, the system supports heterogeneous or homogeneous base learners, parallel computation of ensemble parameters, adaptive validation splits, and deployment across cloud, edge, or distributed computing environments. Experimental results demonstrate improved performance relative to conventional AutoML ensemble selection approaches.

In the following description, for the purposes of explanation, numerous specific details are set forth in order to provide a thorough understanding of implementations of the present technology. It will be apparent, however, to one skilled in the art that implementations of the present technology can be practiced without some of these specific details.

The techniques introduced here can be implemented as special-purpose hardware (e.g., circuitry), as programmable circuitry appropriately programmed with software and/or firmware, or as a combination of special-purpose and programmable circuitry. Hence, implementations can include a machine-readable medium having stored thereon instructions which can be used to program a computer (or other electronic devices) to perform a process. The machine-readable medium can include, but is not limited to, floppy diskettes, optical disks, compact disc read-only memories (CD-ROMs), magneto-optical disks, read-only memories (ROMs), random access memories (RAMs), erasable programmable read-only memories (EPROMs), electrically erasable programmable read-only memories (EEPROMs), magnetic or optical cards, flash memory, or other types of media/machine-readable medium suitable for storing electronic instructions.

The phrases “in some implementations,” “according to some implementations,” “in the implementations shown,” “in other implementations,” “in some embodiments,” and the like generally mean the particular feature, structure, or characteristic following the phrase is included in at least one implementation of the present technology and can be included in more than one implementation. In addition, such phrases do not necessarily refer to the same implementations or different implementations.

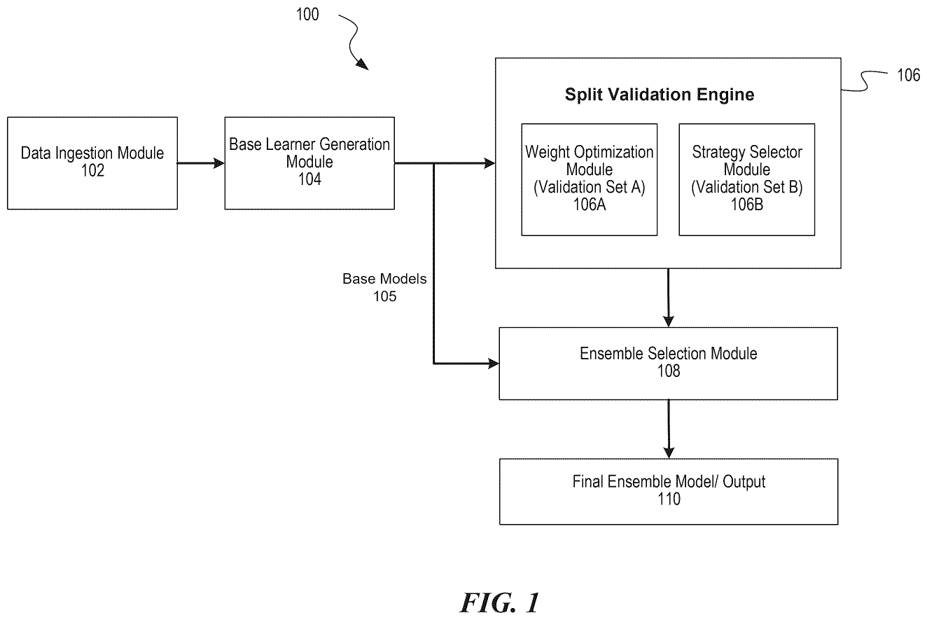

FIG. 1 is a block diagram illustrating an automated machine learning (AutoML) ensemble selection system 100 (hereinafter “AutoESSV system” or “system 100”). The system 100 is configured to automatically select an optimal ensemble strategy from a plurality of candidate ensemble strategies by utilizing a split validation set architecture that isolates weight optimization from strategy evaluation, thereby preventing data leakage and improving generalization performance of the resulting ensemble model. The system 100 addresses technical problems in conventional AutoML ensemble systems, including: (1) overfitting to validation data when the same dataset is used for both weight computation and strategy selection; (2) computational inefficiency resulting from suboptimal ensemble configurations; (3) inability to automatically adapt ensemble strategies to different data characteristics; and (4) data leakage that degrades model generalization. The system 100 provides technical improvements to the functioning of machine learning pipelines by implementing a novel data partitioning architecture that fundamentally changes how ensemble models are trained and selected. The disclosed system 100 specifically addresses the training phase of machine learning operations.

In some embodiments, the system 100 includes a data ingestion module 102 configured to receive input data for a machine learning task. The data ingestion module 102 can comprise one or more data interfaces, parsers, and preprocessing components configured to accept data from various sources. The input data can comprise a dataset including a plurality of samples, each sample having one or more features and an associated target value. The target value can be a class label for classification tasks or a continuous value for regression tasks.

In various embodiments, the data ingestion module 102 is configured to receive data from sources including, without limitation: local file systems, distributed file systems (e.g., HDFS, S3), streaming data sources, database connections, API endpoints, real-time sensor feeds, or live data feeds captured via application programming interfaces (APIs). In some embodiments, the data ingestion module 102 is configured to connect to external data providers via RESTful APIs, WebSocket connections, or other programmatic interfaces to receive training data in real-time or near-real-time. The data ingestion module 102 can support various data formats including, without limitation: CSV, JSON, Parquet, Avro, Excel, SQL databases, or proprietary formats.

In some embodiments, the data ingestion module 102 includes preprocessing capabilities configured to perform one or more of: missing value imputation, outlier detection and handling, feature scaling and normalization, categorical encoding (e.g., one-hot encoding, label encoding, target encoding), feature extraction, dimensionality reduction (e.g., PCA, t-SNE, UMAP), or data augmentation. In other embodiments, the data ingestion module 102 passes raw data to downstream modules without preprocessing.

In some embodiments, the data ingestion module 102 can further include a data partitioning component configured to partition the input data into a training portion and a validation portion. In some embodiments, the data partitioning component allocates approximately 80% of the input data to the training portion and approximately 20% to the validation portion. In other embodiments, different partitioning ratios can be used, such as 70/30, 90/10, or ratios determined dynamically based on dataset size or characteristics. In yet other embodiments, k-fold cross-validation is employed, wherein the data is partitioned into k subsets and the training/validation split is rotated across folds. The data partitioning component is further configured to divide the validation portion into a first validation subset (Validation Set A, in 106A in FIG. 1) and a second validation subset (Validation Set B, in 106B in FIG. 1). In some embodiments, the validation portion is divided equally, with approximately 50% allocated to each validation subset. In other embodiments, unequal splits can be used, such as 60/40, 70/30, or splits determined based on the number of ensemble strategies being evaluated or the complexity of the weight optimization problem provided there is enough data in each dataset to provide the validation. The isolation between Validation Set A and Validation Set B is configured to prevent data leakage during the ensemble selection process. Using the same validation set to determine the weights using different approaches and then using that validation set to benchmark the performance of each approach would cause data leakage. Separating the data for each purpose prevents that.

The system 100 includes a base learner generation module 104 communicatively coupled to the data ingestion module 102. The base learner generation module 104 is configured to train a plurality of base learner models using the training portion of the input data. The base learner generation module 104 outputs trained base models 105 that are provided to downstream modules for ensemble construction.

In some embodiments, the base models 105 comprise extreme learning machines (ELMs) having randomly initialized input-to-hidden layer weights. ELMs are particularly advantageous because their stochastic initialization naturally creates diversity among the base models 105 without requiring explicit diversification mechanisms. The random weight initialization ensures that each ELM learns different feature representations, thereby maximizing the independence of prediction errors across the ensemble, a factor in ensemble effectiveness. In alternative embodiments, the base models 105 can comprise other machine learning model architectures including, without limitation: neural networks; tree-based models; kernel methods; linear models; instance-based methods; probabilistic models; or ensemble base learners.

In some embodiments, the base learner generation module 104 generates a homogeneous ensemble wherein all base models 105 share the same architecture but differ in initialization, training data subsets, or hyperparameters. In other embodiments, the base learner generation module 104 generates a heterogeneous ensemble comprising base models 105 of different architectures, thereby increasing representational diversity. The base learner generation module 104 can employ various diversification strategies including, without limitation: bagging; random subspace method (training each base model on a random subset of features); random initialization (using different random seeds for weight initialization); hyperparameter variation (training base models with different hyperparameter configurations); data augmentation variation (applying different augmentation strategies to different base models); or, negative correlation learning (explicitly penalizing correlation between base model predictions during training).

In some embodiments, the base learner generation module 104 trains a predetermined number of base models (e.g., 10, 50, 100, 500, 1200, etc., base models). In other embodiments, the number of base models is determined dynamically based on computational budget, dataset size, convergence criteria, or diversity metrics. In some embodiments, the number of base models is determined adaptively based on the data before and independently of ensemble generation.

The system 100 includes a split validation engine 106 communicatively coupled to the base learner generation module 104 and receives the trained base models 105. The split validation engine 106 manages the separation between weight optimization and strategy evaluation by utilizing two distinct validation subsets. The split validation engine 106 comprises a weight optimization module 106A and a strategy selector module 106B. The architectural separation of these modules, combined with their use of different validation subsets, constitutes a technical improvement over conventional ensemble selection systems that use a single validation set for both purposes.

The weight optimization module 106A is configured to compute, using a first validation subset (Validation Set A), a plurality of weight sets, wherein each weight set corresponds to a different ensemble strategy from an ensemble strategy pool. The weight optimization module 106A receives predictions generated by applying the base models 105 to Validation Set A and computes optimal weights for each candidate ensemble strategy.

For classification tasks, the ensemble strategy pool can include, without limitation: (1) Single vote (majority voting): Each base model contributes one vote for its predicted class, and the class receiving the most votes is selected. All base models have equal weight (wi=1/N where N is the number of base models); (2) Weighted majority voting: Weights are assigned to each base model based on its individual accuracy on Validation Set A. Models with higher accuracy receive higher weights; (3) Soft voting: Instead of discrete votes, each base model contributes its predicted class probabilities, which are averaged (optionally weighted) to produce final class probabilities; (4) Class-specific soft voting: Weights are computed separately for each class based on each base model's performance on samples of that class. This allows models that excel at predicting certain classes to have higher influence for those classes; (5) class-specific Jaccard weighting: Jaccard similarity coefficients are computed between each base model's predictions and the true labels for each class; (6) Stacked generalization: A meta-learner (e.g., logistic regression, neural network) is trained on the base model predictions to learn optimal combination weights; or, (7) Bayesian model averaging: Weights are computed based on posterior probabilities of each base model given the validation data.

For regression tasks, the ensemble strategy pool can include, without limitation: (1) Simple averaging (single vote): All base model predictions are averaged with equal weights; (2) Mean Absolute Error (MAE) weighted: Weights are computed as the inverse of each base model's MAE on Validation Set A, such that models with lower error receive higher weights; (3) Mean Squared Error (MSE) weighted: Weights are computed as the inverse of each base model's MSE on Validation Set A; (4) Root Mean Squared Error (RMSE) weighted: Weights are computed as the inverse of each base model's RMSE on Validation Set A; (5) Mean Absolute Percentage Error (MAPE) weighted: Weights are computed as the inverse of each base model's MAPE on Validation Set A; (6) Integer programming optimization: An optimization problem is formulated to find coefficients for each base model that minimize prediction error on Validation Set A. The coefficients are constrained to values between zero and one (0≤wi≤1) and optionally constrained to sum to one (Σwi=1). The optimization can be solved using linear programming, quadratic programming, or mixed-integer programming solvers; (7) LASSO-based weight selection: L1-regularized regression is applied to learn sparse weights that automatically select a subset of base models; (8) Ridge-based weight computation: L2-regularized regression is applied to learn weights that prevent any single base model from dominating; (9) Elastic net weight computation: Combined L1 and L2 regularization for weight learning; or, (10) Neural network meta-learner: A neural network is trained to learn non-linear combinations of base model predictions.

In some embodiments, the weight optimization module 106A computes weights for all ensemble strategies in the pool in parallel, leveraging multi-core processors, GPUs, or distributed computing resources. In other embodiments, weights are computed sequentially or in a prioritized order based on computational complexity.

The strategy selector module 106B is configured to evaluate, using a second validation subset (Validation Set B), the performance of each ensemble strategy using its corresponding weight set computed by the weight optimization module 106A. Validation Set B is distinct from and isolated from Validation Set A, ensuring that the strategy selection process evaluates generalization performance rather than fit to the weight optimization data.

In some embodiments, the strategy selector module 106B receives: (1) the trained base models 105; (2) the weight sets computed by the weight optimization module 106A; and (3) Validation Set B. For each ensemble strategy, the strategy selector module 106B: (i) Generates predictions from each base model for samples in Validation Set B; (ii) Combines the base model predictions using the weight set corresponding to that ensemble strategy; and (iii) Computes one or more performance metrics comparing the combined predictions to the true target values in Validation Set B.

For classification tasks, performance metrics can include, without limitation: accuracy, F1 score (macro, micro, or weighted), precision, recall, area under the ROC curve (AUC-ROC), area under the precision-recall curve (AUC-PR), Cohen's kappa, Matthews correlation coefficient, log loss, or Brier score.

For regression tasks, performance metrics can include, without limitation: mean squared error (MSE), root mean squared error (RMSE), mean absolute error (MAE), mean absolute percentage error (MAPE), R-squared (coefficient of determination), adjusted R-squared, Pearson correlation coefficient, Spearman correlation coefficient, or median absolute error.

In some embodiments, the strategy selector module 106B compares the performance metrics across all evaluated ensemble strategies and identifies the ensemble strategy achieving the optimal performance metric on Validation Set B. The optimal strategy can be the strategy with the highest accuracy, highest F1 score, lowest MSE, highest correlation, average Jaccard score, minimum Jaccard score, or other metric depending on the task and user configuration.

In some embodiments, the strategy selector module 106B employs statistical significance testing (e.g., paired t-test, Wilcoxon signed-rank test, McNemar's test) to determine whether performance differences between strategies are statistically significant. In such embodiments, the strategy selector module 106B can select a simpler strategy if its performance is not statistically significantly worse than a more complex strategy.

The system 100 includes an ensemble selection module 108 communicatively coupled to the split validation engine 106. The ensemble selection module 108 receives the selected ensemble strategy and corresponding weight set from the strategy selector module 106B and constructs the final ensemble configuration. In some embodiments, the ensemble selection module 108 can perform additional optimization or refinement steps including, without limitation: ensemble pruning (removing base models with negligible weights or negative contribution to ensemble performance); weight normalization (scaling weights to sum to one or to have unit norm); threshold calibration (adjusting classification thresholds for optimal precision-recall tradeoffs); probability calibration (applying Platt scaling, isotonic regression, or temperature scaling to calibrate predicted probabilities); hyperparameter fine-tuning (refining any strategy-specific hyperparameters). In some embodiments, the ensemble selection module 108 stores metadata about the selection process, including: the performance metrics achieved by each candidate strategy, the selected strategy and rationale, the computed weight sets, and timestamps for reproducibility and auditing purposes. In some embodiments, the strategy selection module 106B selects the final ensemble weights to be used removing the need for the ensemble selection module 108.

The system 100 includes a final ensemble model 110 that represents the output of the training operations performed by the AutoESSV system 100. The final ensemble model 110 comprises: (1) the trained base models 105; (2) the selected ensemble strategy; and (3) the optimized weight set for the selected strategy. The final ensemble model 110 is a trained metamodel that encapsulates the base learners and their ensemble weights as determined during training. Once training is complete and the final ensemble model 110 is produced, the model is available for deployment and inference. At inference time (which is a separate phase from the training operations described herein), a new input sample can be processed by applying the base learners to generate individual predictions, which are then combined using the ensemble weights to produce a final prediction. In various embodiments, the final ensemble model 110 can be deployed in environments including, without limitation: cloud computing platforms (e.g., AWS, Azure, GCP), edge devices, embedded systems, mobile applications, web services, batch processing pipelines, or real-time streaming systems. The final ensemble model 110 can be serialized and stored in formats including, without limitation: pickle files, ONNX format, PMML, TensorFlow SavedModel, PyTorch checkpoints, or custom binary formats. The serialization includes all information necessary to reconstruct the ensemble for inference without access to the original training data.

The system 100 provides several technical advantages over conventional ensemble selection systems: (1) Prevention of data leakage: By using separate validation subsets for weight optimization (Validation Set A) and strategy evaluation (Validation Set B), the system 100 prevents the strategy selection process from overfitting to the weight optimization data; (2) Improved generalization: The isolated evaluation on Validation Set B provides an unbiased estimate of how well each ensemble strategy will generalize to new, unseen data; (3) Reduced computational waste: By automatically selecting the optimal ensemble strategy, the system 100 avoids deploying suboptimal ensemble configurations that waste computational resources during inference; (4) Adaptive strategy selection: Unlike fixed-strategy systems, the system 100 automatically adapts to the characteristics of each dataset, selecting strategies that work best for the specific data distribution; (5) Memory efficiency: The split validation architecture stores only the data partitions and weight sets, rather than full models for each candidate strategy; (6) Parallelization opportunities: The weight computation for different strategies can be parallelized, and the base model predictions can be cached and reused across strategies, improving computational efficiency.

In some embodiments, the system 100 is configured for online or streaming scenarios where data arrives continuously, for example, where the input dataset is obtained from a live or continuously updated data source, including via an application programming interface (API), streaming service, or network-connected data feed. The split validation engine 106 maintains sliding windows for Validation Sets A and B and periodically re-evaluates and updates the selected ensemble strategy during ongoing training operations. In such embodiments, training data may be periodically captured, buffered, or windowed from the live data feed and used to retrain or update the ensemble model using the split validation process described herein.

In some embodiments, the strategy selector module 106B evaluates strategies based on multiple objectives (e.g., accuracy and inference latency) and selects a pareto-optimal strategy or uses a weighted combination of objectives.

In some embodiments, the final ensemble model 110 serves as a base model in a higher-level ensemble, enabling multi-level stacking architectures.

In some embodiments, the system 100 operates in a federated setting where base models are trained on decentralized data sources and ensemble selection is performed on aggregated validation metrics.

In some embodiments, the system 100 is integrated with broader AutoML pipelines that also optimize feature engineering, data preprocessing, and base model hyperparameters.

In some embodiments, the system 100 includes an explainability module that provides insights into why a particular ensemble strategy was selected and how individual base models contribute to predictions (e.g., generates metadata identifying a rationale for selecting the ensemble strategy).

In some embodiments, the final ensemble model 110 outputs uncertainty estimates (e.g., prediction intervals, confidence scores) in addition to point predictions.

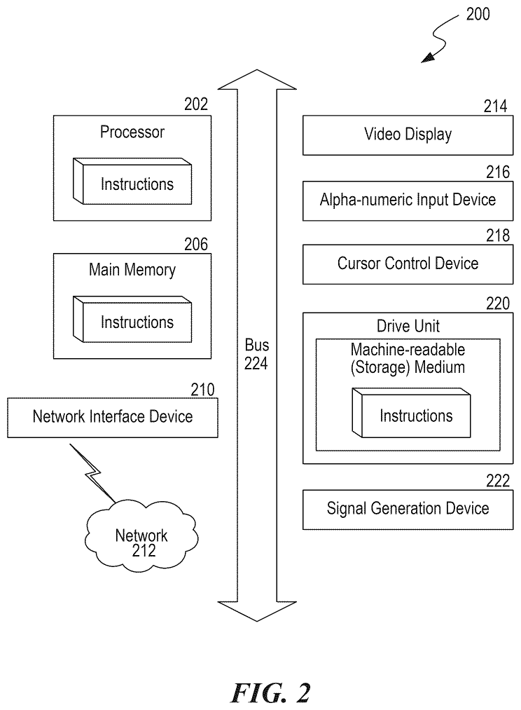

FIG. 2 is a diagrammatic representation of a machine in the example form of a computer system or machine 200 within which a set of instructions, when executed, can cause the machine to perform any one or more of the processes described above. In some embodiments, the machine 200 operates as a standalone device, while in other embodiments, the machine 200 can be connected (e.g., networked) to other machines. In a networked deployment, the machine 200 can operate in the capacity of a server or a client user machine in a client-server network environment, or as a peer machine in a peer-to-peer (or distributed) network environment. The machine can include other network components (e.g., cloud computing devices and/or servers). While a single machine is illustrated, the machine 200 can include any collection of machines that individually or jointly execute instructions to perform any of the methods described herein.

The machine 200 can include a processor 202, a main memory 206 and a bus 224. The bus 224 can include a subsystem for transferring data between the components of the machine 200, including transferring data between the main memory 206 and the processor 202. The bus 224 can represent one or more separate physical buses, point to point connections, or both, connected by appropriate bridges, adapters, or controllers. The machine 200 can also include a display device 214, one or more input devices 216, a cursor control device 218 (e.g., a mouse or touch-screen interface), a drive unit 220, a signal generation device or output device 222 (e.g., a speaker, a remote control, etc.) and a network interface device 210, among others.

The processor(s) 202 can control the overall operation of the machine 200. The processor(s) 202 can execute computer programs or firmware stored in memory (for example, 206, 220). The processor(s) 202 can include one or more programmable general-purpose or special-purpose microprocessors, digital signal processors (“DSPs”), programmable controllers, application specific integrated circuits (“ASICs”), programmable logic devices (“PLDs”), trusted platform modules (“TPMs”), or the like, or a combination thereof.

The main memory 206 represents any form of memory (e.g., RAM, ROM, flash memory, or the like) or a combination of such devices connected to the bus 224. The drive unit 220 can include a machine-readable medium or machine-readable storage medium that stores, encodes or carries one or more sets of instructions for execution by the machine 200 to perform any or all of the methods described herein. It should be noted that the term “machine-readable medium” and “machine-readable storage medium” can include a single medium or multiple media (e.g., a centralized or distributed database, and/or associated caches and servers) that store the one or more sets of instructions embodying any or all of the methods described herein.

In general, the routines executed to implement the embodiments of the disclosure can be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

The network interface device 210 allows the machine 200 to mediate data in various networks with one or more entities that are external to the machine, through any known and/or convenient communications standards and protocols supported by the machine 200 and the external entities. Example protocols supported by the machine 200 include, but are not limited to: IP protocols for the application layer, transport layer protocols, Internet layer protocols, link layer protocols, LTE protocols, 3G/4G/5G protocols, etc. The network interface device 210 can include one or more of a network adaptor card, a wireless network interface card, a router, an access point, a wireless router, a switch, a multilayer switch, a protocol converter, a gateway, a bridge, a bridge router, a hub, a digital media receiver, a repeater, or other interfaces for supporting the various protocols. Although the present disclosure describes the components and functions implemented in the embodiments with reference to particular standards and protocols that represent examples of the state of the art, the disclosure is not limited to such standards and protocols, and includes functional equivalents that can supersede the current state of the art.

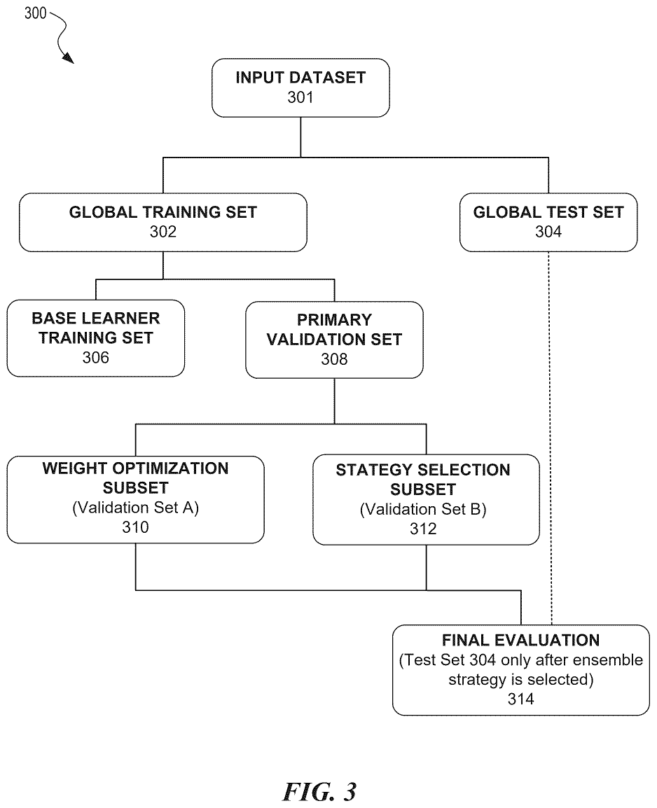

FIG. 3 illustrates a dataset partitioning and split validation architecture 300. The architecture 300 depicts the hierarchical partitioning of an input dataset into distinct subsets used for training, weight optimization, strategy selection, and final evaluation.

An input dataset 301 is initially partitioned into a global training set 302 and a global test set 304. In some embodiments, the global training set 302 comprises approximately 80% of the input dataset 301, and the global test set 304 comprises approximately 20% of the input dataset 301. In alternative embodiments, other partitioning ratios can be employed, such as 70/30, 75/25, 90/10, or ratios determined dynamically based on dataset size, feature dimensionality, or cross-validation requirements (e.g., k-fold cross-validation where k can be 5, 10, or another value).

The global training set 302 is further partitioned into a base learner training set 306 and a primary validation set 308. In some embodiments, the base learner training set 306 comprises approximately 80% of the global training set 302, and the primary validation set 308 comprises approximately 20% of the global training set 302. In other embodiments, other partitions other than 80/20 can be employed as described above. The base learner training set 306 is used for training the plurality of base learner models as described with reference to the base learner generation module 104 of FIG. 1.

The primary validation set 308 is subdivided into a weight optimization subset 310 (also referred to as “Validation Set A”) and a strategy selection subset 312 (also referred to as “Validation Set B”). In some embodiments, the weight optimization subset 310 and the strategy selection subset 312 each comprise approximately 50% of the primary validation set 308. In alternative embodiments, unequal splits such as 60/40, 70/30, or 40/60 can be used depending on the number of candidate ensemble strategies, the complexity of the weight optimization problem, or computational constraints provided that the subsets are large and diverse enough to represent the dataset.

The weight optimization subset 310 is used by the weight optimization module 106A (FIG. 1) to compute weight sets for each candidate ensemble strategy. The strategy selection subset 312 is used by the strategy selector module 106B (FIG. 1) to evaluate the performance of each ensemble strategy using the weight sets computed from subset 310.

The architecture 300 provides isolation between the weight optimization subset 310 and the strategy selection subset 312. Weight computation operations use only subset 310, while strategy evaluation operations use only subset 312. This isolation prevents data leakage that would otherwise occur if the same data were used for both weight optimization and strategy evaluation, thereby ensuring that the strategy selection process provides an unbiased estimate of generalization performance.

The global test set 304 is held out and reserved for final evaluation 314 of the selected ensemble model. The final evaluation 314 is performed only after the ensemble strategy has been selected using the strategy selection subset 312. This hold-out methodology ensures that the global test set 304 provides an independent assessment of the final ensemble model's performance on unseen data. The dashed connection between the global test set 304 and the final evaluation 314 indicates this reserved, hold-out relationship.

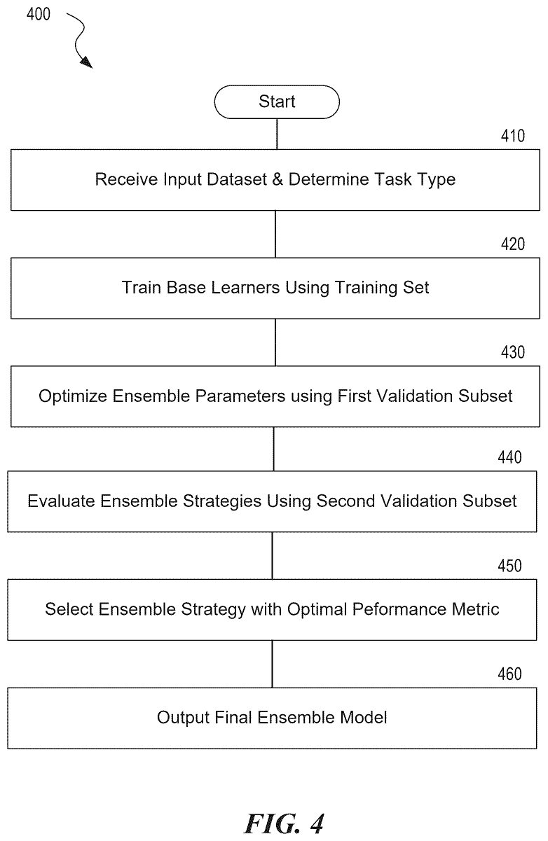

FIG. 4 illustrates a method 400 for automated ensemble strategy selection using split validation sets. The method 400 can be performed by the system 100 described with reference to FIG. 1, utilizing the data partitioning architecture 300 described with reference to FIG. 3.

At block 410, an input dataset is received and a task type is determined. The input dataset comprises a plurality of samples, each sample having one or more features and an associated target value. The task type determination identifies whether the machine learning task is a classification task, a regression task, or other machine learning task (e.g., clustering, ranking, anomaly detection, recommendation, forecasting, representation learning, decision optimization, generative AI, etc.). In some embodiments, the task type is determined automatically based on the nature of the target values; discrete class labels indicate a classification task, while continuous numerical values indicate a regression task, etc. In other embodiments, the task type is specified by a user or inferred from metadata associated with the input dataset. The input dataset can be partitioned according to the data partitioning architecture 300 (FIG. 3) to generate a training set 306, a first validation subset 310 (Validation Set A), and a second validation subset 312 (Validation Set B).

At block 420, a plurality of base learner models are trained using the training set 306. This operation corresponds to the function of the base learner generation module 104 described with reference to FIG. 1. In some embodiments, the base learner models comprise extreme learning machines (ELMs) having randomly initialized input-to-hidden layer weights, which naturally creates diversity among the base learners. In alternative embodiments, the base learner models can comprise neural networks (e.g., feedforward networks, convolutional neural networks, recurrent neural networks), decision trees, random forests, gradient boosting machines, support vector machines, or combinations thereof. The trained base learner models are provided to subsequent blocks for ensemble construction and evaluation.

At block 430, ensemble parameters are optimized using the first validation subset 310 (Validation Set A). This operation corresponds to the function of the weight optimization module 106A described with reference to FIG. 1. At block 430, a plurality of weight sets are computed, wherein each weight set corresponds to a different candidate ensemble strategy from an ensemble strategy pool.

For classification tasks, the ensemble strategy pool can include strategies such as single vote (majority voting), weighted majority voting, soft voting, class-specific soft voting, class-specific Jaccard weighting, or stacked generalization. For regression tasks, the ensemble strategy pool can include strategies such as simple averaging, MAE-weighted averaging, MSE-weighted averaging, RMSE-weighted averaging, MAPE-weighted averaging, or integer programming optimization.

The weight computation process generates predictions from the trained base learner models for samples in the first validation subset 310, and computes optimal weights for each candidate strategy based on the performance of each base learner on this subset. The computed weight sets are provided to block 440 for strategy evaluation.

At block 440, ensemble strategies are evaluated using the second validation subset 312 (Validation Set B). This operation corresponds to the function of the strategy selector module 106B described with reference to FIG. 1. At block 440, each candidate ensemble strategy is evaluated by: (1) generating predictions from the trained base learner models for samples in the second validation subset 312; (2) combining the base learner predictions according to the weight set computed for that strategy at block 430; and (3) computing one or more performance metrics comparing the combined predictions to the true target values in the second validation subset 312.

Blocks 430 and 440 operate on isolated, separate validation subsets. The weight optimization at block 430 uses only the first validation subset 310, while the strategy evaluation at block 440 uses only the second validation subset 312. This isolation prevents data leakage that would otherwise occur if the same data were used for both weight computation and strategy evaluation, thereby ensuring unbiased strategy selection and improved generalization performance.

At block 450, the ensemble strategy having the optimal performance metric on the second validation subset 312 is selected. For classification tasks, the optimal performance metric can comprise the highest F1 score (macro, micro, or weighted), highest accuracy, highest Area Under the Receiver Operating Characteristic Curve (AUC-ROC), or other classification metric. For regression tasks, the optimal performance metric cany comprise the lowest mean squared error (MSE), lowest root mean squared error (RMSE), highest Pearson correlation coefficient, highest R-squared value, or other regression metric.

In some embodiments, the selection at block 450 is automatic, selecting the strategy with the single best performance metric. In other embodiments, statistical significance testing can be performed to determine whether performance differences are significant, and a simpler strategy can be selected if its performance is not statistically significantly worse than a more complex strategy.

At block 460, a final ensemble model is output. The final ensemble model comprises: (1) the trained base learner models from block 420; (2) the selected ensemble strategy from block 450; and (3) the weight set corresponding to the selected strategy as computed at block 430. The final ensemble model represents the trained metamodel produced by the training method 400. Once produced, the final ensemble model can be used for inference (a separate operation from the training method 400) by applying the trained base learners to new input data and combining their individual predictions using the selected strategy and weight set to produce a final prediction. This corresponds to the final ensemble model 110 described with reference to FIG. 1.

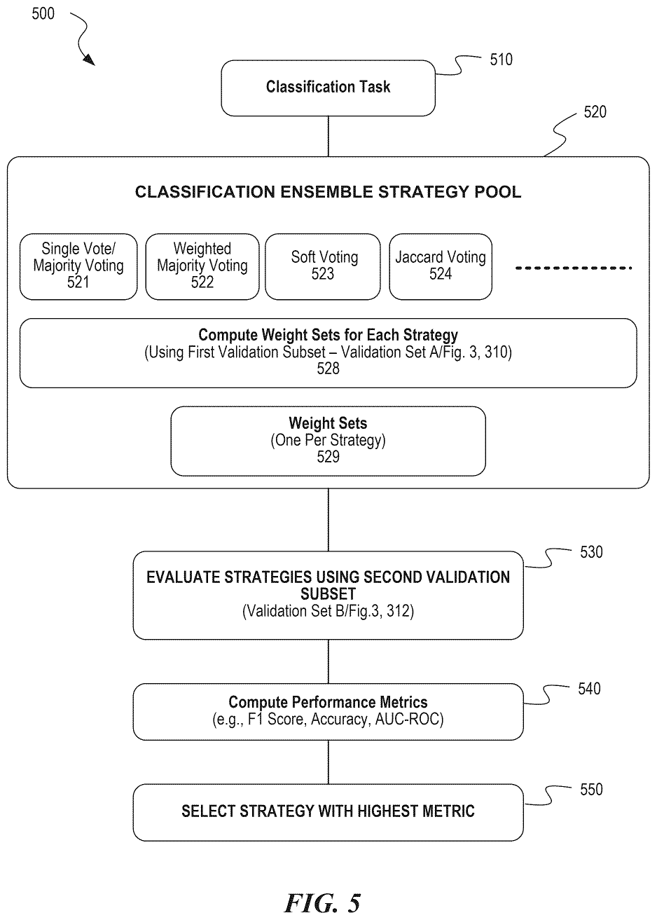

FIG. 5 is a block diagram illustrating classification ensemble strategy selection 500 and provides additional detail for blocks 430 and 440 of FIG. 4 when the machine learning task determined at block 410 is a classification task. Accordingly, the classification task 510 receives trained base learners from block 420 of FIG. 4 based on the task type determination performed at block 410.

A classification ensemble strategy pool 520 comprises a plurality of candidate ensemble strategies for combining base learner predictions in classification tasks. In some embodiment, the classification ensemble strategy pool 520 includes a single vote/majority voting strategy 521, a weighted majority voting strategy 522, a soft voting strategy 523, and a Jaccard voting strategy 524. The dashed line in FIG. 5 indicates that additional or different classification strategies can be included in the pool in alternative embodiments.

The single vote/majority voting strategy 521 assigns equal weight to each base learner, with the final prediction determined by the class receiving the most votes across all base learners. This approach treats all base learners as equally reliable regardless of their individual performance characteristics. The weighted majority voting strategy 522 assigns weights to each base learner based on its individual accuracy on the first validation subset. Base learners with higher accuracy receive higher weights. The soft voting strategy 523 (also referred to as probability aggregation) aggregates the predicted class probabilities from each base learner rather than discrete class predictions. The class probabilities are averaged (optionally weighted) across all base learners, and the class with the highest aggregated probability is selected as the final prediction. The Jaccard voting strategy 524 (also referred to as class-specific Jaccard weighting) computes Jaccard similarity coefficients between each base learner's predictions and the true labels for each class. In alternative embodiments, the classification ensemble strategy pool 520 can include additional strategies such as: stacked generalization (training a meta-learner on base learner predictions), class-specific soft voting (computing class-specific weights based on per-class performance metrics), similarity weighting (weighting based on prediction similarity or diversity among base learners), Bayesian model averaging, boosting-based combination methods, or other voting-based ensemble methods known in the art.

At block 528, weight sets are computed for each strategy in the classification ensemble strategy pool 520 using the first validation subset (Validation Set A, reference 310 as described with reference to FIG. 3). For each candidate strategy, the weight computation block 528 generates predictions from the trained base learners for samples in Validation Set A and computes the appropriate weights according to that strategy's weighting algorithm.

The computed weight sets 529 are output from block 528, with one weight set corresponding to each candidate strategy in the pool. Each weight set defines how the base learner predictions will be combined under its corresponding strategy.

At block 530, each ensemble strategy is evaluated using the second validation subset (Validation Set B, reference 312 as described with reference to FIG. 3). For each strategy, the base learner predictions for samples in Validation Set B are combined according to the corresponding weight set from block 528, and the combined predictions are compared against the true target values.

At block 540, performance metrics are computed for each strategy. In various embodiments, performance metrics can include F1 score (macro, micro, or weighted), accuracy, precision, recall, area under the ROC curve (AUC-ROC), area under the precision-recall curve (AUC-PR), Cohen's kappa, Matthews correlation coefficient, log loss, Brier score, or other classification metrics appropriate for the dataset characteristics.

At block 550, the strategy having the highest performance metric on the second validation subset is selected. The selected strategy and corresponding weight set are returned to block 450 of FIG. 4 for inclusion in the final ensemble model output at block 460.

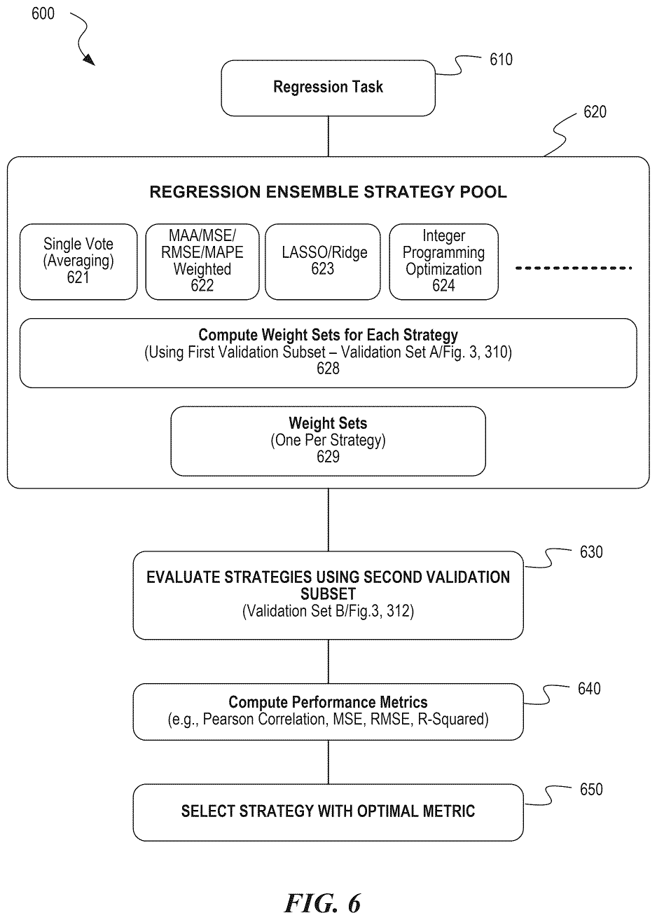

FIG. 6 is a block diagram illustrating regression ensemble strategy selection 600 and provides additional detail for blocks 430 and 440 of FIG. 4 when the machine learning task determined at block 410 is a regression task. Accordingly, the regression task 610 receives trained base learners from block 420 of FIG. 4 based on the task type determination performed at block 410.

A regression ensemble strategy pool 620 comprises a plurality of candidate ensemble strategies for combining base learner predictions in regression tasks. In some embodiments, the regression ensemble strategy pool 620 includes a single vote/averaging strategy 621, metric-weighted strategies 622 (including MAE, MSE, RMSE, and MAPE weighting), regularization-based strategies 623 (including LASSO and Ridge), and an integer programming optimization strategy 624. The dashed line in FIG. 6 indicates that additional or different regression strategies can be included in the pool in alternative embodiments.

The single vote/averaging strategy 621 assigns equal weights to all base learners, with the final prediction computed as the simple average of all base learner predictions. This approach provides a baseline ensemble that does not favor any particular base learner. The metric-weighted strategies 622 assign weights to base learners based on the inverse of their error metrics computed on the first validation subset (for MAE, weights are computed as the inverse of each base learner's mean absolute error; for MSE, weights are computed as the inverse of each base learner's mean squared error; for RMSE, weights are computed as the inverse of each base learner's root mean squared error; for MAPE, weights are computed as the inverse of each base learner's mean absolute percentage error). The regularization-based strategies 623 apply regularization techniques to learn ensemble weights: LASSO applies L1-regularized regression to learn sparse weights that automatically select a subset of base learners by driving some weights to zero while Ridge applies L2-regularized regression to learn weights that prevent any single base learner from dominating the ensemble. The integer programming optimization strategy 624 formulates a constrained optimization problem to find optimal coefficients for each base learner. In alternative embodiments, the regression ensemble strategy pool 620 can include additional strategies such as: linear programming optimization, quadratic programming optimization, mixed-integer programming (with integer constraints on coefficient values), elastic net (combined L1 and L2 regularization), neural network meta-learners, gradient boosting of residuals, or other optimization-based or ensemble weighting methods known in the art.

At block 628, weight sets are computed for each strategy in the regression ensemble strategy pool 620 using the first validation subset (Validation Set A, reference 310 as described with reference to FIG. 3). For each candidate strategy, the weight computation block 628 generates predictions from the trained base learners for samples in Validation Set A and computes the appropriate weights according to that strategy's weighting algorithm or optimization procedure. The computed weight sets 629 are output from block 628, with one weight set corresponding to each candidate strategy in the pool.

At block 630, each ensemble strategy is evaluated using the second validation subset (Validation Set B, reference 312 as described with reference to FIG. 3). For each strategy, the base learner predictions for samples in Validation Set B are combined according to the corresponding weight set from block 628, and the combined predictions are compared against the true target values.

At block 640, performance metrics are computed for each strategy. In various embodiments, performance metrics can include Pearson correlation coefficient, mean squared error (MSE), root mean squared error (RMSE), mean absolute error (MAE), mean absolute percentage error (MAPE), R-squared (coefficient of determination), adjusted R-squared, Spearman correlation coefficient, or other regression metrics appropriate for the dataset characteristics.

At block 650, the strategy having the optimal performance metric (e.g., highest correlation coefficient or lowest error metric) on the second validation subset is selected. The selected strategy and corresponding weight set are returned to block 450 of FIG. 4 for inclusion in the final ensemble model output at block 460.

The effectiveness of the automated ensemble selection system and method described herein (referred to as “AutoESSV”) was evaluated through extensive benchmarking experiments against, for example, the Auto-Sklearn library. Auto-Sklearn employs the forward model selection procedure for ensemble construction. The experiments utilized sixteen diverse datasets from the UCI Machine Learning Repository, comprising eight classification datasets and eight regression datasets.

For both classification and regression experiments, the data was partitioned using 5-fold cross-validation, with 80% allocated for training and 20% for testing in each fold. Within the training set, 80% was used to train individual base learners and 20% was allocated for validation. The validation set was further split 50/50, with half used to compute model weights (Validation Set A, reference 310) and the remaining half used to evaluate ensemble strategies (Validation Set B, reference 312), consistent with the data partitioning architecture described with reference to FIG. 3.

Extreme learning machines (ELMs) were employed as base learners due to their stochastic nature, which naturally creates diversity among base learners, a factor in ensemble effectiveness. To ensure fair comparison, Auto-Sklearn was configured with no data or feature preprocessing and a maximum processing time of 30 minutes, and the same trained base learners were provided to both methods.

Table I below presents the characteristics of the classification datasets used in the experiments while Table II presents the characteristics of the regression datasets used in the experiments.

Tables III to X present classification benchmarking results. Table III presents ensemble performance on the Car Evaluation dataset, where the task is to evaluate the acceptability of cars based on structural characteristics. On this dataset, the weighted average approach attains the best performance among the base inducers. The AutoESSV approach attained an even higher F1 score due to variations of the two validation sets-AutoESSV achieved a significantly higher F1 score (0.8739) compared to Auto-Sklearn (0.8033), representing approximately an 8.8% improvement.

Table IV presents ensemble performance on the Balance Scale dataset. The Jaccard weighting approach attained the highest performance among the base inducers. The AutoESSV selection approach chose this method and performed comparably. AutoESSV outperformed Auto-Sklearn with an F1 score of 0.7184 versus 0.7135.

Table V presents ensemble performance on the Synthetic Control dataset. The class-specific Jaccard weighting approach performed best among the base inducers. Notably, AutoESSV chose this method as the optimal ensemble approach for this dataset and attained significantly better performance than Auto-Sklearn. AutoESSV selected the Jaccard weighting approach and achieved significantly better performance (F1=0.9700) than Auto-Sklearn (F1=0.9500).

Table VI presents ensemble performance on the CMC dataset. The variance in performance across methods on this dataset is minimal. AutoESSV once again outperforms Auto-Sklearn. AutoESSV outperformed Auto-Sklearn with an F1 score of 0.5282 versus 0.4983.

Table VII presents ensemble performance on the Student Success dataset. The performance across ensembles is balanced on this dataset. Notably, AutoESSV outperforms Auto-Sklearn, choosing the Jaccard weighting approach as the base inducer. AutoESSV selected the Jaccard weighting approach and outperformed Auto-Sklearn.

Table VIII presents ensemble performance on the CNAE-9 dataset. With the exception of the class-specific soft voting ensemble, performance is balanced across methods. AutoESSV attained slightly better performance than Auto-Sklearn.

Table IX presents ensemble performance on the Iris dataset. AutoESSV chose the optimal strategy, albeit performance is similar across strategies. Performance was identical between AutoESSV and Auto-Sklearn on this dataset.

Table X presents ensemble performance on the Dry Bean dataset. On this final classification dataset, Auto-Sklearn narrowly outperforms AutoESSV. The best performing base inducer was the Jaccard approach (0.9373 vs 0.9371).

Tables XI to XVIII present regression benchmarking results. Table XI presents ensemble performance on the Abalone dataset, where the task is to predict the age of abalone from physical measurements. Notably, AutoESSV outperforms Auto-Sklearn according to both metrics.

Table XII presents ensemble performance on the Concrete Compressive Strength dataset, where the task is to predict the compressive strength of various concrete samples. Notably, AutoESSV significantly outperforms Auto-Sklearn, with integer programming performing best among the base inducers. AutoESSV significantly outperformed Auto-Sklearn (Pearson 0.8952 vs 0.8265), with integer programming achieving the best performance among base strategies.

Table XIII presents ensemble performance on the QSAR Aquatic Toxicity dataset, where the task is to predict the toxicity of certain molecules. Again, AutoESSV outperforms Auto-Sklearn with a Pearson correlation of 0.717 versus 0.6525.

Table XIV presents ensemble performance on the Superconductivity dataset, where the task is to predict the critical temperature of 21,263 superconductors. Once again, AutoESSV outperforms Auto-Sklearn. AutoESSV achieved substantially better performance (Pearson 0.9396, MSE 136.57) compared to Auto-Sklearn (Pearson 0.8992, MSE 244.203).

Table XV presents ensemble performance on the Appliance Energy Prediction dataset, where the task is to predict the energy usage of various household appliances. In this dataset, AutoESSV significantly outperforms Auto-Sklearn.

Table XVI presents ensemble performance on the Airfoil dataset, which was created by NASA for the purpose of modeling aerodynamics and acoustics. AutoESSV significantly outperforms Auto-Sklearn on this dataset as well (Pearson 0.8999 vs 0.8111, MSE 9.41 vs 16.4).

Table XVII presents ensemble performance on the Yacht Hydrodynamics dataset, where the task is to predict the hydrodynamic performance of sailing yachts. AutoESSV slightly outperforms Auto-Sklearn in this experiment with a Pearson correlation of 0.8507 versus 0.8378.

Table XVIII presents ensemble performance on the Wine Quality dataset, where the task is to predict the quality of wine using physicochemical variables. AutoESSV outperformed Auto-Sklearn on this final regression dataset.

### Classification Datasets

TABLE I
CLASSIFICATION DATASETS

| Dataset | N features | N samples | N classes |
|---|---|---|---|
| Balance Scale | 23 | 839 | 3 |
| Synthetic Control | 60 | 600 | 6 |
| Car Evaluation | 6 | 1728 | 4 |
| Contraceptive | 9 | 1473 | 9 |
| Student Success | 36 | 4424 | 3 |
| CNAE-9 | 856 | 1080 | 9 |
| Iris | 4 | 150 | 3 |
| Dry Bean | 15 | 13,610 | 7 |

### Regression Datasets

TABLE II
REGRESSION DATASETS

| Dataset | N features | N samples |
|---|---|---|
| Abalone | 8 | 4177 |
| Concrete | 8 | 1030 |
| QSAR Aquatic | 8 | 546 |
| Energy | 27 | 19734 |
| Superconductivity | 81 | 21263 |
| Airfoil | 5 | 1502 |
| Yacht | 6 | 307 |
| Wine Quality | 11 | 6497 |

### Classification Benchmarking Results

TABLE III
ENSEMBLE PERFORMANCE ON CAR EVALUATION

| Method | F1 Score | Accuracy |
|---|---|---|
| AutoESSV | 0.8739 | 0.9357 |
| AutoSklearn | 0.8033 | 0.8981 |
| Jaccard | 0.8535 | 0.9172 |
| Weighted average | 0.8559 | 0.9178 |
| Class-specific soft voting | 0.8415 | 0.9317 |
| Single vote | 0.8522 | 0.9143 |

TABLE IV
ENSEMBLE PERFORMANCE ON BALANCE SCALE

| Method | F1 Score | Accuracy |
|---|---|---|
| AutoESSV | 0.7184 | 0.9103 |
| AutoSklearn | 0.7135 | 0.9070 |
| Jaccard | 0.7328 | 0.9184 |
| Weighted average | 0.7256 | 0.9152 |
| Class-specific soft voting | 0.7212 | 0.9008 |
| Single vote | 0.7256 | 0.9152 |

TABLE V
ENSEMBLE PERFORMANCE ON SYNTHETIC CONTROL

| Method | F1 Score | Accuracy |
|---|---|---|
| AutoESSV | 0.9700 | 0.9633 |
| AutoSklearn | 0.9500 | 0.9500 |
| Jaccard | 0.9698 | 0.9693 |
| Weighted average | 0.9681 | 0.9683 |
| Class-specific soft voting | 0.9131 | 0.9148 |
| Single vote | 0.9664 | 0.9666 |

TABLE VI
ENSEMBLE PERFORMANCE ON CMC DATASET

| Method | F1 Score | Accuracy |
|---|---|---|
| AutoESSV | 0.5282 | 0.5288 |
| AutoSklearn | 0.4983 | 0.5234 |
| Jaccard | 0.4983 | 0.5234 |
| Weighted average | 0.5180 | 0.5268 |
| Class-specific soft voting | 0.5039 | 0.5200 |
| Single vote | 0.5155 | 0.5248 |

TABLE VII
ENSEMBLE PERFORMANCE ON
STUDENT SUCCESS DATASET

| Method | F1 Score | Accuracy |
|---|---|---|
| AutoESSV | 0.6745 | 0.7527 |
| AutoSklearn | 0.6657 | 0.7415 |
| Jaccard | 0.6801 | 0.7520 |
| Weighted average | — | 0.7524 |
| Class-specific soft voting | 0.6517 | 0.7269 |
| Single vote | 0.6779 | 0.7513 |

TABLE VIII
ENSEMBLE PERFORMANCE ON CNAE-9 DATASET

| Method | F1 Score | Accuracy |
|---|---|---|
| AutoESSV | 0.9296 | 0.9398 |
| AutoSklearn | 0.9292 | 0.9256 |
| Jaccard | 0.9392 | 0.9388 |
| Weighted average | 0.9383 | 0.9379 |
| Class-specific soft voting | 0.7790 | 0.8091 |
| Single vote | 0.9292 | 0.9425 |

TABLE IX
ENSEMBLE PERFORMANCE ON IRIS DATASET

| Method | F1 Score | Accuracy |
|---|---|---|
| AutoESSV | 0.9351 | 0.9398 |
| AutoSklearn | 0.9351 | 0.9395 |
| Jaccard | 0.9532 | 0.9533 |
| Weighted average | 0.9531 | 0.9533 |
| Class-specific soft voting | 0.9531 | 0.9533 |
| Single vote | 0.9532 | 0.9533 |

TABLE X
ENSEMBLE PERFORMANCE ON DRY BEAN DATASET

| Method | F1 Score | Accuracy |
|---|---|---|
| AutoESSV | 0.9371 | 0.9247 |
| AutoSklearn | 0.9373 | 0.9274 |
| Jaccard | 0.9245 | 0.9149 |
| Weighted average | 0.9241 | 0.9135 |
| Class-specific soft voting | 0.9140 | 0.9023 |
| Single vote | 0.9009 | 0.8891 |

### Regression Benchmarking Results

TABLE XI
ENSEMBLE PERFORMANCE ON ABALONE DATASET

| Method | Pearson | MSE |
|---|---|---|
| AutoESSV | 0.7664 | 4.3898 |
| AutoSklearn | 0.7501 | 4.8831 |
| MAE | 0.7664 | 4.501 |
| RMSE | 0.7668 | 4.502 |
| MSE | 0.7674 | 4.4917 |
| MAPE | 0.7663 | 4.5108 |
| Single vote | 0.7664 | 4.514 |
| Integer programming | 0.7617 | 4.385 |

TABLE XII
ENSEMBLE PERFORMANCE ON CONCRETE
COMPRESSIVE STRENGTH DATASET

| Method | Pearson | MSE |
|---|---|---|
| AutoESSV | 0.8952 | 55.62 |
| AutoSklearn | 0.8265 | 76.08 |
| MAE | 0.8586 | 77.635 |
| RMSE | 0.8584 | 77.887 |
| MSE | 0.8620 | 76.011 |
| MAPE | 0.8563 | 79.144 |
| Single vote | 0.8545 | 79.883 |
| Integer programming | 0.8952 | 55.941 |

TABLE XIII
ENSEMBLE PERFORMANCE ON QSAR
AQUATIC TOXICITY DATASET

| Method | Pearson | MSE |
|---|---|---|
| AutoESSV | 0.717 | 1.405 |
| AutoSklearn | 0.6525 | 1.64 |
| MAE | 0.6827 | 1.549 |
| RMSE | 0.709 | 1.549 |
| MSE | 0.6913 | 1.545 |
| MAPE | 0.6794 | 1.564 |
| Single vote | 0.6816 | 1.554 |
| Integer programming | 0.7118 | 1.399 |

TABLE XIV
ENSEMBLE PERFORMANCE ON
SUPERCONDUCTIVITY DATASET

| Method | Pearson | MSE |
|---|---|---|
| AutoESSV | 0.9396 | 136.57 |
| AutoSklearn | 0.8992 | 244.203 |
| MAE | 0.9127 | 210.732 |
| RMSE | 0.9111 | 215.229 |
| MSE | 0.9201 | 192.151 |
| MAPE | 0.8998 | 242.21 |
| Single vote | 0.8992 | 244.203 |
| Integer programming | 0.9396 | 138.496 |

TABLE XV
ENSEMBLE PERFORMANCE ON
ENERGY PREDICTION DATASET

| Method | Pearson | MSE |
|---|---|---|
| AutoESSV | 0.6011 | 6813.25 |
| AutoSklearn | 0.5409 | 8011.78 |
| MAE | 0.5405 | 8005.84 |
| RMSE | 0.6011 | 7967.05 |
| MSE | 0.5982 | 7923.18 |
| MAPE | 0.5459 | 8335.41 |
| Single vote | 0.5409 | 8011.78 |
| Integer programming | 0.5988 | 6803.93 |

TABLE XVI
ENSEMBLE PERFORMANCE ON AIRFOIL DATASET

| Method | Pearson | MSE |
|---|---|---|
| AutoESSV | 0.8999 | 9.41 |
| AutoSklearn | 0.8111 | 16.4 |
| MAE | 0.8454 | 14.17 |
| RMSE | 0.8474 | 14.1993 |
| MSE | 0.8546 | 13.679 |
| MAPE | 0.8393 | 14.679 |
| Single vote | 0.8373 | 14.7356 |
| Integer programming | 0.8999 | 9.41 |

TABLE XVII
ENSEMBLE PERFORMANCE ON YACHT DATASET

| Method | Pearson | MSE |
|---|---|---|
| AutoESSV | 0.8507 | 47.825 |
| AutoSklearn | 0.8378 | 70.467 |
| MAE | 0.7976 | 88.9882 |
| RMSE | 0.7958 | 88.862 |
| MSE | 0.7955 | 87.938 |
| MAPE | 0.7663 | 4.5108 |
| Single vote | 0.7955 | 89.683 |
| Integer programming | 0.8343 | 64.806 |

TABLE XVIII
ENSEMBLE PERFORMANCE ON WINE QUALITY DATASET

| Method | Pearson | MSE |
|---|---|---|
| AutoESSV | 0.6399 | 0.4514 |
| AutoSklearn | 0.6221 | 0.4788 |
| MAE | 0.6115 | 0.4875 |
| RMSE | 0.6113 | 0.4877 |
| MSE | 0.6122 | 0.4865 |
| MAPE | 0.6103 | 0.4868 |
| Single vote | 0.6104 | 0.4891 |
| Integer programming | 0.6430 | 0.4482 |

The experimental results demonstrate the effectiveness of the automated ensemble selection approach described herein. Across the sixteen benchmark datasets, AutoESSV outperformed the state-of-the-art Auto-Sklearn library on fourteen datasets, with Auto-Sklearn slightly outperforming AutoESSV on only one dataset (Dry Bean) and achieving identical performance on one dataset (Iris).

The results validate that the split validation architecture (using separate validation subsets for weight optimization and strategy evaluation) enables more effective ensemble strategy selection compared to conventional single-validation approaches. By preventing data leakage between the weight computation and strategy evaluation phases, the disclosed technology achieves improved generalization performance on unseen test data. Notably, the experimental results also demonstrate the value of including diverse ensemble strategies in the candidate pool. On some datasets, the class-specific Jaccard weighting approach achieved the best performance, while on others, integer programming optimization or metric-weighted averaging performed best. The ability of AutoESSV to automatically select the optimal strategy for each dataset, rather than being constrained to a single fixed strategy, contributes to its superior overall performance.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of implementations of the system is not intended to be exhaustive or to limit the system to the precise form disclosed above. While specific implementations of, and examples for, the system are described above for illustrative purposes, various equivalent modifications are possible within the scope of the system, as those skilled in the relevant art will recognize. For example, some elements or components are described herein as performing certain functions. Those functions could be performed by other elements or components in the same or differing systems, which could reduce the number of elements. Alternatively, or additionally, elements performing those functions could be replaced by two or more elements to perform portions of those functions. In addition, while processes, message/data flows, or blocks are presented in a given order, alternative implementations may perform routines having blocks, or employ systems having blocks, in a different order, and some processes or blocks may be deleted, moved, added, subdivided, combined, and/or modified to provide alternative or subcombinations. Each of these processes, message/data flows, or blocks may be implemented in a variety of different ways. Also, while processes or blocks are at times shown as being performed in series, these processes or blocks may instead be performed in parallel, or may be performed at different times. Further, any specific numbers noted herein are only examples; alternative implementations may employ differing values or ranges.

The teachings of the methods and system provided herein can be applied to other systems, not necessarily the system described above. The elements, blocks, and acts of the various implementations described above can be combined to provide further implementations.

Any patents and applications and other references noted above, including any that may be listed in accompanying filing papers, are incorporated herein by reference. Aspects of the technology can be modified, if necessary, to employ the systems, functions, and concepts of the various references described above to provide yet further implementations of the technology.

These and other changes can be made to the invention in light of the above Detailed Description. While the above description describes certain implementations of the technology, and describes the best mode contemplated, no matter how detailed the above appears in text, the invention can be practiced in many ways. Details of the system may vary considerably in its implementation details, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the invention to the specific implementations disclosed in the specification, unless the above Detailed Description section explicitly defines such terms. Accordingly, the actual scope of the invention encompasses not only the disclosed implementations, but also all equivalent ways of practicing or implementing the invention under the claims.

While certain aspects of the technology are presented below in certain claim forms, the inventors contemplate the various aspects of the technology in any number of claim forms. For example, while only one aspect of the invention is recited as implemented in a computer-readable medium, other aspects may likewise be implemented in a computer-readable medium. Accordingly, the inventors reserve the right to add additional claims after filing the application to pursue such additional claim forms for other aspects of the technology.

1. A system for automated ensemble strategy selection, the system comprising:
one or more processors; and
one or more non-transitory computer-readable media storing instructions that, when executed by the one or more processors, cause the one or more processors to perform operations comprising:
receiving an input dataset for a machine learning task;
partitioning the input dataset into at least a training set, a first validation subset, and a second validation subset, wherein the first validation subset and the second validation subset are isolated from each other;
training a plurality of base learner models using the training set;
computing, using the first validation subset, a plurality of weight sets as ensemble parameters, wherein each weight set corresponds to a different candidate ensemble strategy;
evaluating, using the second validation subset, each candidate ensemble strategy based on the corresponding weight set;
selecting an ensemble strategy having an optimal performance metric on the second validation subset; and
outputting a trained ensemble model comprising the plurality of base learner models and the selected ensemble strategy.

2. The system of claim 1, wherein the first validation subset is excluded from evaluation of performance metric of the candidate ensemble strategies, and the second validation subset is excluded from computation of ensemble parameters.

3. The system of claim 1, wherein the ensemble strategy for a classification task includes at least one of majority voting, weighted majority voting, soft voting, class-specific soft voting, or class-specific Jaccard weighting.

4. The system of claim 1, wherein the ensemble strategy for a regression task includes metric-weighted averaging based on at least one of mean absolute error, mean squared error, root mean squared error, or mean absolute percentage error.

5. The system of claim 1, wherein computing the plurality of weight sets using the first validation subset comprises computing weight sets for at least two of the candidate ensemble strategies in parallel.

6. The system of claim 1, further comprising an explainability module configured to generate metadata identifying a rationale for selecting the ensemble strategy.

7. A computer-implemented method for automated ensemble strategy selection, the method comprising:
receiving, by one or more processors, an input dataset for a machine learning task, the input dataset comprising a plurality of samples each having one or more features and an associated target value;
partitioning, by the one or more processors, the input dataset into at least a training set, a first validation subset, and a second validation subset, wherein the first validation subset and the second validation subset are isolated from each other;
training, by the one or more processors, a plurality of base learner models using the training set;
computing, by the one or more processors using the first validation subset, a plurality of weight sets by optimizing ensemble parameters, wherein each weight set corresponds to a different candidate ensemble strategy from an ensemble strategy pool;
evaluating, by the one or more processors using the second validation subset, each candidate ensemble strategy by combining one or more predictions from the plurality of base learner models according to the corresponding weight set and computing a performance metric for each candidate ensemble strategy;
selecting, by the one or more processors, an ensemble strategy from the ensemble strategy pool based on the performance metrics, wherein the selected ensemble strategy has an optimal performance metric on the second validation subset; and
outputting a final ensemble model comprising the plurality of base learner models, the selected ensemble strategy, and the weight set corresponding to the selected ensemble strategy.

8. The method of claim 7, wherein the plurality of base learner models comprise extreme learning machines (ELMs) having randomly initialized input-to-hidden layer weights.

9. The method of claim 7, wherein the machine learning task is a regression task, and wherein the ensemble strategy pool comprises at least two of simple averaging, a mean absolute error (MAE) weighted averaging, a mean squared error (MSE) weighted averaging, a root mean squared error (RMSE) weighted averaging, and an integer programming optimization.

10. The method of claim 7, wherein the optimal performance metric comprises at least one of a highest F1 score, a highest accuracy, a lowest mean squared error, or a highest Pearson correlation coefficient.

11. The method of claim 7, wherein partitioning the input dataset comprises:
partitioning the input dataset into a global training set comprising approximately 80% of the input dataset and a global test set comprising approximately 20% of the input dataset;
partitioning the global training set into the training set comprising approximately 80% of the global training set and a primary validation set comprising approximately 20% of the global training set; and
partitioning the primary validation set into the first validation subset comprising approximately 50% of the primary validation set and the second validation subset comprising approximately 50% of the primary validation set.

12. The method of claim 7, wherein the computing using the first validation subset and the evaluating using the second validation subset are performed on isolated data.

13. The method of claim 12, wherein the optimizing ensemble parameters using the first validation subset and the selecting the ensemble strategy using the second validation subset are performed on mutually exclusive subsets of validation data.

14. The method of claim 7, wherein selecting the ensemble strategy comprises selecting a candidate ensemble strategy that maximizes an F1 score computed on the second validation subset.

15. The method of claim 7, wherein optimizing ensemble parameters comprises solving a constrained optimization problem subject to bounds on ensemble weights.

16. The method of claim 7, wherein optimizing ensemble parameters comprises computing weight sets for at least two candidate ensemble strategies in parallel.

17. A non-transitory computer-readable medium storing instructions that, when executed by one or more processors, cause the one or more processors to perform a method for automated ensemble strategy selection, the method comprising:
receiving an input dataset comprising a plurality of samples;
partitioning the input dataset into a training set, a first validation subset, and a second validation subset;
training a plurality of base learner models using the training set;
computing, using the first validation subset, weight sets as ensemble parameters for a plurality of candidate ensemble strategies;
evaluating, using the second validation subset, the plurality of candidate ensemble strategies using the weight sets;
selecting a candidate ensemble strategy based on performance on the second validation subset; and
generating a final ensemble model based on the selected candidate ensemble strategy.

18. The non-transitory computer-readable medium of claim 17, wherein the instructions cause the one or more processors to compute the ensemble parameters using the first validation subset and to evaluate the candidate ensemble strategies using the second validation subset, the first validation subset and the second validation subset being isolated from each other.

19. The non-transitory computer-readable medium of claim 18, wherein the instructions cause the one or more processors to compute the ensemble parameters and to select the candidate ensemble strategy using mutually exclusive subsets of validation data.

20. The non-transitory computer-readable medium of claim 17, wherein the instructions cause the one or more processors to optimize the ensemble parameters by computing weight sets for at least two candidate ensemble strategies in parallel.
